(19) United States
(12) Patent Application Publication
(10) Pub. No.: US 2016/0240024 A1
(43) Pub. Date: Aug. 18, 2016

(54) ELECTRONIC COMPONENT FOR AN ID TRANSMITTER OF A VEHICLE

(71) Applicant: Huf Hüisbeck & Fürst GmbH & Co. KG, Velbert (DE)

(72) Inventors: Jörg SIMON, Wülfrath (DE); Steffen DAMELANG, Wiehl (DE); Gianni USELLI, Velbert (DE)

(21) Appl. No.: 15/025,897

(22) PCT Filed: Aug. 21, 2014
(86) PCT No.: PCT/EP2014/067790

§ 371 Date: Mar. 30, 2016

(30) Foreign Application Priority Data
Sep. 30, 2013 (DE) 10 2013 110 819.9

(51) Int. Cl. G07C 9/00

(52) U.S. Cl. CPC G07C 9/00309; G07C 9/00111

(57) ABSTRACT

The invention relates to an electronic component (10) for an ID transmitter (100) of a vehicle, having at least one radio module (30) for communicating for an authorization request of the vehicle, wherein at least one near-field communication module (40) is provided for communicating in the near field (12) of the electronic component (10).

The present invention relates to an electronic component for an ID transmitter of a vehicle according to the preamble of Claim 1 and a corresponding ID transmitter for a vehicle with an associated electronic component according to the preamble of Claim 10.

It is known that vehicles have electronic ID transmitters which fulfil a mechanical key- and access function. Such electronic ID transmitters serve for this purpose for example to send by radio an authorization query to the vehicle for the unlocking of the doors. In response to this query, usually the release occurs or respectively a secured communication sequence, to clarify the authorization and accordingly to carry out the unlocking of the vehicle. For example, via a communication sequence with a security query and a security response, a corresponding authorization request can take place. This takes place usually by radio already several metres away from the vehicle.

A disadvantage in known electronic components for ID transmitters or respectively in corresponding ID transmitters is that these can fulfil exclusively the authorization function. Known ID transmitters do not have further, additional functionalities or only have them insufficiently. Furthermore, an integration of further functionalities into the radio module would involve a high degree of effort, because in such a case the authorization functionality must not be permitted to be impaired in its security.

It is the object of the present invention to at least partially eliminate the disadvantages described above. In particular, it is the object of the present invention to provide in a cost-efficient and simple manner a greater functional range of the ID transmitter.

The above problem is solved by an electronic component having the features of Claim 1 and an ID transmitter having the features of Claim 10. Further features and details of the invention will emerge from the respective subclaims, the description and the drawings. Here, features and details which are described in connection with the electronic component according to the invention of course also apply in connection with the ID transmitter according to the invention and vice versa respectively, so that with respect to the disclosure reference is or respectively can always be made reciprocally to the individual aspects of the invention.

An electronic component according to the invention is constructed for the ID transmitter of a vehicle. For this, the electronic component has at least one radio module for communicating for an authorization query of the vehicle. An electronic component according to the invention is distinguished in that at least one near-field communication module is provided for communicating in the near field of the electronic component.

According to the invention, the electronic component is therefore based on known ID transmitters. Thus, it uses a radio module in order to be able to carry out in a known manner the communication for an authorization request of the vehicle. This can take place in the described functionality of a security question and a security response. Of course, other radio methods are also able to be realized for carrying out an authorization request of the vehicle in the present electronic component.

In addition to the radio module, a near-field communication module is now provided according to the invention. This serves for communicating in the near field of the electronic component. The near field of the electronic component is to be understood here to mean the region around less than approximately one metre around the electronic component. Preferably, smaller communication ranges are provided in the near field, so that the near field preferably has less than approximately 50 cm communication range or even less.

By the provision of a near-field communication module according to the invention, additional functionalities can now be implemented in the electronic component. These are implemented in particular on the near-field communication module, so that the radio module can carry out, unimpaired thereby, its known functionality for the authorization request. Through the separate structural configuration of radio module on the one hand and near-field communication module on the other hand, standard components can be used for the radio module and preferably also for the near-field communication module. These can be arranged e.g. jointly on a printed circuit board or on separate printed circuit boards connected with one another in a signal-communicating manner. Such an electronic component is subsequently incorporated into the ID transmitter of a vehicle, in order to be able to guarantee the corresponding two different communication types for this ID transmitter.

The near field for communicating with the near-field communication module is limited in particular even to a range which presupposes a contact with the electronic component or respectively the ID transmitter. In other words, the communication can only take place in the near field when the corresponding opposite communication interface has an actual touching contact with the ID transmitter. It is to be pointed out here that this touching contact is not a signal-communicating contact, but rather represents the threshold starting from which the associated opposite communication interface would leave the near field for communication.

An example for the above functionality is a communication in the interior of the vehicle. Thus, for example, after the unlocking of the doors, the driver can open the door and enter the vehicle. Subsequently, it is possible that he deposits the key, which is constructed here as an ID transmitter in the manner according to the invention, in the centre console of the vehicle. On being deposited, the ID transmitter and thereby also the electronic component comes in contact with the corresponding deposition surface in the centre console of the vehicle. If a corresponding opposite communication interface is now situated in the centre console of the vehicle, this communication can only take place in the near field when the key, i.e. the ID transmitter, has actually been deposited into the centre console. Thus, misuse for communication in the near-field communication module can be prevented with greater security. In this described example, of course also a somewhat greater communication range can be permitted for the near field. Thus, for example, a near field in the range of approximately 10-20 cm is conceivable, so that in the described variant the key can also remain in the driver's trouser pocket.

As becomes clear from the above example, through the reduction of the communication range of the near-field communication module to a correspondingly restricted near field, a local security function is fulfilled. Thus, it can be ensured that the user only carries out the corresponding communication with the near-field communication module when arranged locally in a defined manner near enough to the corresponding opposite communication interface. Through this local association between ID transmitter with near-field communication module on the one hand and the opposite communication interface on the other hand, a high degree of security is achieved. An interception of the data or respectively an undesired communication can be prevented with a high degree of certainty, so that additional security functions within the near-field communication module can be omitted. Therefore, also, critical data between the near-field communication module and a corresponding opposite communication interface can be exchanged, without a high security radio standard having to be maintained as in the radio module. Here, also, again the additional advantage arises, which is able to be achieved through the combination, according to the invention, of radio module and near-field communication module.

The communication with the near-field communication module can take place according to the most varied standards. Preferably the so-called NFC standard (near-field communication) or for example a near-field Bluetooth method is used.

Through the provision of a communication according to the invention in the near field with the aid of the near-field communication module, a plurality of the most varied functionalities can now be additionally transmitted to the electronic component. Thus, for example, personalizable settings of the vehicle can be exchanged via the communication in the near field with the vehicle. Here, this can be, for example the adjusting of the exterior mirrors or the adjusting of the seat. More critical parameters, such as e.g. the setting of the chassis or the shift points of an automatic gearbox can also be transmitted with increased security in this way.

It can be advantageous if in an electronic component according to the invention the at least one near-field communication module is constructed with one of the following modes of operation:
NFC (Near-field Communication)
Near-field Bluetooth

The above itemization is not a conclusive list. Of course, other radio possibilities can also be selected for the near-field communication module, as long as a corresponding restriction of the communication to the near field is possible in a defined manner. The using of the two above standards allows one to have recourse to existing standard components. In particular, the near-field communication module can be a standard component, whereby the costs of an electronic component according to the invention are further reduced.

A further advantage is able to be achieved if in an electronic component according to the invention the near field for communicating with the near-field communication module has an extent of less than approximately 10 cm around the near-field communication module, in particular is restricted to a contact to the electronic component. As has already been explained several times, the reduction of the communication range, i.e. the definition of the near field, is achieved through the construction of the near-field communication module. A reduction of the geometric extent of the near field leads to the described local security function. Therefore, ranges of less than 10 cm, in particular of less than approximately 5 cm, approximately 3 cm or respectively approximately 1 cm, are preferred. A contact to the electronic component is to be understood to the effect that a touching contact to the electronic component or respectively to the ID transmitter is produced through the corresponding opposite communication interface. This means that the communication can only take place with a holding against the corresponding communication interface or a placing thereon. This increases the local security function, as has already been explained several times.

It is also advantageous if in an electronic component according to the invention a proximity sensor is provided, in particular in the region of the near-field communication module. It is thereby ensured that the communication of the near-field communication module only starts when also in fact a corresponding object, in particular the associated communication interface, is arranged in the sufficiently near vicinity. In addition to the increased security, thereby the energy consumption of the electronic component, and in particular of the near-field communication module, can be reduced. Thus, preferably, the communication attempt with the near-field communication module is only started when the proximity sensor emits a sufficient probability for the arrangement of a corresponding opposite communication interface. For example, the electronic component has a control unit which in particular is constructed as a small CPU and undertakes the corresponding regulating of the near-field communication module or respectively the processing of the data of the proximity sensor.

In addition, it can be advantageous if in an electronic component according to the invention the near-field communication module is constructed for carrying out at least one of the following functions:
payment function
locking function of a vehicle
personalizing of a vehicle
personalizing of authorization functions of a vehicle
authorization function for access areas.

The above enumeration is a non-conclusive list. Of course, further functions can also provide a corresponding additional functionality for the electronic component. With the payment function, e.g. a payment in restaurants can be made available. However, additional services can also be activated within the vehicle, which are charged with costs by the vehicle manufacturer. Through the ID transmitter, the payment process can be allocated to the owner of the associated ID transmitter, so that a corresponding payment function is made available. The locking function of the vehicle can also be ensured in this way, if e.g. by holding against a defined outer surface of the vehicle the unlocking of the vehicle is carried out. The personalizing of individual functions of the vehicle can be designed e.g. for a locking release for the luggage compartment. Thus, e.g. the luggage compartment can only be opened with the aid of the ID transmitter. For delivery in the workshop, e.g. the locking release for the luggage compartment can be reduced via the near-field communication module, or e.g. a maximum speed of approximately 100 km/h can be set for the vehicle. Of course, the authorization functionality can also comprise regions remote from the vehicle, therefore e.g. can serve as access function in a company.

It is, in addition, advantageous if in an electronic component according to the invention the radio module is coupled with the near-field communication module in particular via a control unit provided for this, so that in particular the communication with the near-field communication module is only released when a confirmation of the authorization communication with the radio module has taken place. This means that an additional security function for the communication with the near-field communication module is introduced. However, this does not have to be implemented separately in the near-field communication module. Rather, already the existing security through the radio module is used, and through the downstream connection or respectively dependence of the communication of the near-field communication module is additionally transmitted thereto. Thereby, a further reduction of the costs with an increase of security becomes possible.

A further advantage becomes achievable if in an electronic component according to the invention the radio module has at least one coil, in particular two coils, preferably three coils aligned substantially at right-angles to one another. Thereby, with regard to the alignment of the electronic component during the radio connection an independence of the actual local positioning is achieved. Therefore, a so-called 3D coil results, which can produce an optimized radio connection to the vehicle through the right-angled alignment of the individual coils to one another in a known manner.

It can be a further advantage if with an electronic component according to the invention the near-field communication module has at least one near-field coil, preferably two near-field coils, in particular three near-field coils. The near-field coils can also be constructed at right-angles to one another. As also for the radio module, thereby the near-field communication module can provide an alignment independence, which independently of the actual position of the electronic component can provide the desired communication in the near field. Preferably, the respective near-field coils are provided with approximately 10 or more windings.

In the embodiment of the preceding two paragraphs, it can be advantageous if the at least one coil of the radio module and the at least one near-field coil of the communication module are wound jointly. This is to be understood to mean that in the case of the winding, this takes place around a shared coil core. Here, the coil and the near-field coil can be wound parallel to one another at least in sections. Preferably, the windings are aligned around a shared axis aligned parallel to one another. Also, it is possible in this manner to further improve and increase the compactness of the electronic component. Thus, it can be advantageous if in the electronic component the compact construction of a shared winding of all coils of the radio module and of all near-field coils of the near-field communication module is present. Thus, e.g. through software activation or corresponding soldering at separate soldering points the functionality can be provided through the near-field communication module individually and thereby in a targeted manner.

An ID transmitter for a vehicle with an electronic component having at least one radio module for communicating for an authorization request of the vehicle is also a subject of the present invention. An ID transmitter according to the invention is distinguished in that at least one near-field communication module is provided for communicating in the near field of the electronic component. Here, the electronic component is preferably constructed in a manner according to the invention. Thereby, the ID transmitter according to the invention brings with it the same advantages as have been explained in detail with reference to an electronic component according to the invention.

An ID transmitter according to the invention can be further developed in that a housing is provided, wherein the near-field communication module extends at least in sections along the housing. Thereby, in particular the described possibility of the touching contact is facilitated as restriction for the communication with the near-field communication module.

Thus, a very great reduction of the actually present near field can be carried out, whereby also the necessary transmission power of the near-field communication module and, associated therewith, the necessary current consumption are also reduced.

A security system for a vehicle, having at least one radio interface and at least one near-field communication interface, which can communicate in a corresponding manner with the radio module or respectively with the near-field communication module of an ID transmitter according to the invention or respectively of an electronic component according to the invention, is also a subject of the present invention. Thereby, the same advantages are achieved for the security system as have been explained in detail with reference to an ID-transmitter according to the invention and to an electronic component according to the invention.

Further advantages, features and details of the invention will emerge from the following description, in which example embodiments of the invention are described in detail with reference to the drawings. Here, the features mentioned in the claims and in the description can be essential to the invention respectively individually on their own or in any desired combination. There are shown diagrammatically:

FIG. 1 a first embodiment of an ID transmitter with an electronic component according to the invention,

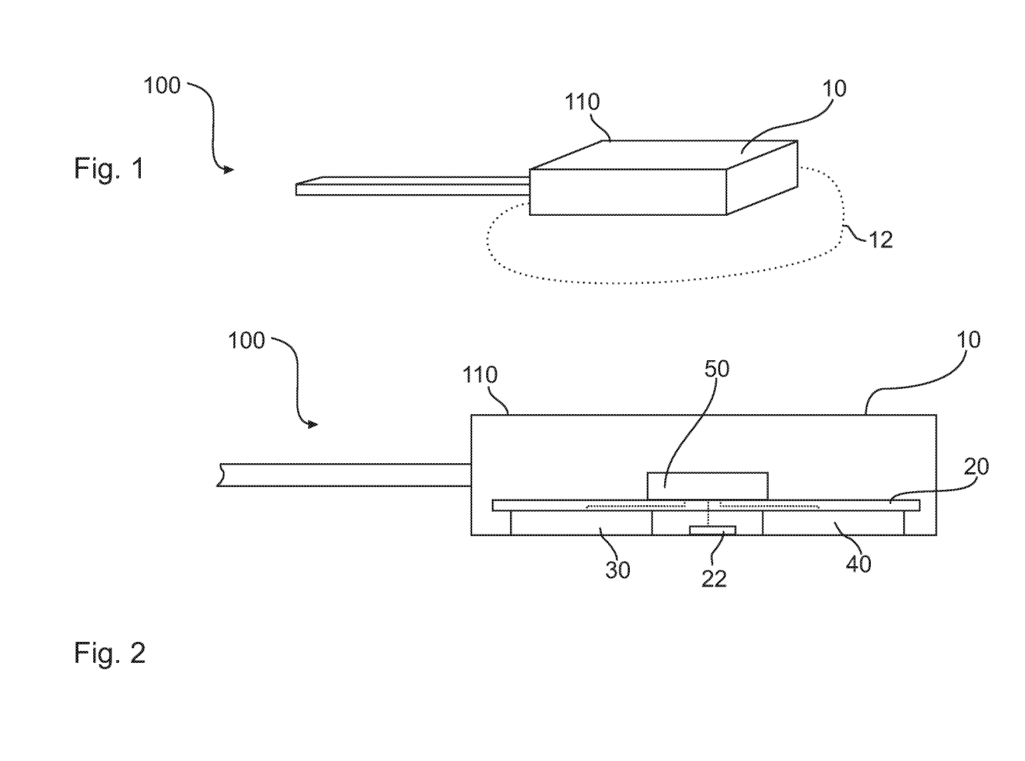

FIG. 2 a further embodiment of an ID transmitter according to the invention with an electronic component according to the invention,

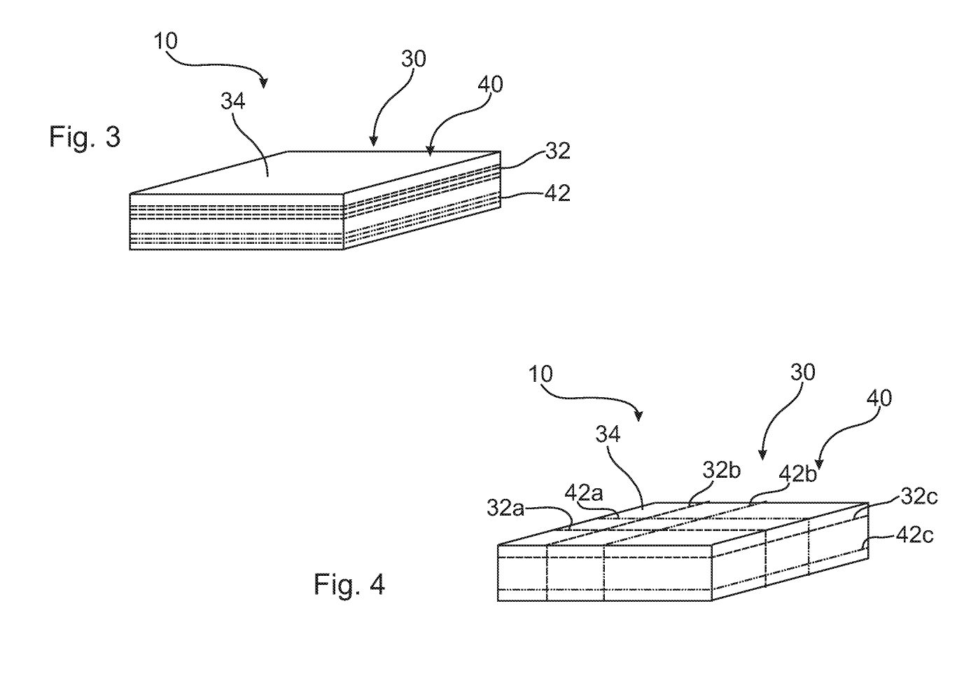

FIG. 3 a further embodiment of an electronic component according to the invention and

FIG. 4 a further embodiment of an electronic component according to the invention.

In the figures, the identical reference numbers are used for the same technical features also for different further developments and example embodiments of the invention.

In FIG. 1 a first embodiment of an ID transmitter 100 according to the invention is illustrated diagrammatically. Within a housing 110, an electronic component 10 is constructed in a manner according to the invention, which permits a near field 12 for communicating with a near field communication module 40 (not illustrated in FIG. 1). The corresponding definition of the near field 12 can also be transferred to the further FIGS. 2 to 4.

FIG. 2 shows a cross-section through a further embodiment of an ID transmitter 100 according to the invention. Here, also, an electronic component 10 is provided in a manner according to the invention, which in this embodiment has a shared printed circuit board 20. A near-field communication module 40 and a radio module 30 are arranged on this printed circuit board 20. A signal-communicating connection to the radio module 30 and to the near-field communication module 40 takes place via a control unit 50. In addition, a proximity sensor 22 is provided at the edge of the housing 110, in order to only switch on the communication possibility with the near-field communication module 40 when a corresponding opposite communication interface is situated close enough thereto and is detected by the proximity sensor 22.

FIG. 3 shows a possibility of the construction of a near-field communication module 40 and radio module 30. Here, both modules have coils 32 and 42, wherein the coils 32 of the radio module 30 and the near-field coils 42 of the near-field communication module 40 are wound jointly around an axis aligned substantially parallel to one another. The winding follows around a shared coil core 34.

FIG. 4 shows a further development of the embodiment of FIG. 3, wherein for reasons of clarity for each winding direction only a single winding is illustrated for the coil 32 and the near-field coil 42. Here, it can be readily seen that around the different winding axes around the coil core 34 near-field coils 42a, 42b and 42c and coils 32a, 32b and 32c are wound, which can be aligned at least partially at right-angles to one another. The winding takes place respectively preferably jointly, so that for both modules, i.e. the radio module 30 and the near-field communication module 40, a three-dimensional functionality arises, which makes the local alignment of the electronic component 10 and of the ID transmitter 100 immaterial for the actual communication.

The above explanation of the embodiments describes the present invention exclusively within the framework of examples. Of course, individual features of the embodiments, in so far as technically expedient, can be combined freely with one another, without departing from the scope of the present invention.

### LIST OF REFERENCE NUMBERS

10 electronic component
12 near field
20 printed circuit board
22 proximity sensor
30 radio module
32 coil
32a coil
32b coil
32c coil
34 coil core
40 near-field communication module
42 near-field coil
42a near-field coil
42b near-field coil
42c near-field coil
50 control unit
100 ID transmitter
110 housing

1. An electronic component (10) for an ID transmitter (100) of a vehicle, having at least one radio module (30) for communicating for an authorization request of the vehicle,
characterized in that
at least one near-field communication module (40) is provided for communicating in the near field of the electronic component (10).

2. The electronic component (10) according to claim 1,
characterized in that
the at least one near-field communication module (40) is constructed with one of the following modes of operation:
NFC (Near-field Communication)
Near-field Bluetooth.

3. The electronic component (10) according to claim 1,
characterized in that
the near field (12) for communicating with the near-field communication module (40) has an extent of less than approximately 10 cm around the near-field communication module (40).

4. The electronic component (10) according to claim 1,
characterized in that
a proximity sensor (22) is provided.

5. The electronic component (10) according to claim 1,
characterized in that
the near-field communication module (40) is constructed for carrying out at least one of the following functions:
payment function
locking function of a vehicle
personalizing a vehicle
personalizing of authorization functions of a vehicle
authorization function for access areas.

6. The electronic component (10) according to claim 1,
characterized in that
the radio module (30) is coupled with the near-field communication module (40).

7. The electronic component (10) according to claim 1,
characterized in that
the radio module (30) has at least one coil (32).

8. The electronic component (10) according to claim 1,
characterized in that
the near-field communication module (40) has at least one near-field coil (42).

9. The electronic component (10) according to claim 1,
characterized in that
the at least one coil (32) of the radio module (30) and the at least one near-field coil (42) of the near-field communication module (40) are wound jointly.

10. An ID transmitter (100) for a vehicle with an electronic component (10), having at least one radio module (30) for communicating for an authorization request of the vehicle,
characterized in that
at least one near-field communication module (20) is provided for a communication in the near field (12) of the electronic component (10).

11. The ID transmitter (100) according to claim 10,
characterized in that
the electronic component (10) has at least the features of one radio module (30) for communicating for an authorization request of the vehicle, wherein at least one near-field communication module (40) is provided for communicating in the near field of the electronic components (10).

12. The ID transmitter (100) according to claim 10,
characterized in that
a housing (110) is provided, wherein the near-field communication module (40) extends at least in sections along the housing (110).
